(19) United States
(12) Patent Application Publication
(10) Pub. No.: US 2023/0337208 A1
(43) Pub. Date: Oct. 19, 2023

(54) BEAM ACTIVATION BASED ON PCI

(71) Applicant: QUALCOMM Incorporated, San Diego, CA (US)

(72) Inventors: Yan ZHOU, San Diego, CA (US); Fang YUAN, Beijing (CN); Mostafa KHOSHNEVISAN, San Diego, CA (US); Tao LUO, San Diego, CA (US)

(21) Appl. No.: 18/008,397

(22) PCT Filed: Jul. 31, 2020
(86) PCT No.: PCT/CN2020/106152

§ 371 Date: Dec. 5, 2022

(51) Int. Cl. H04W 72/044; H04B 7/022; H04W 72/231

(52) U.S. Cl. CPC H04W 72/046; H04B 7/022; H04W 72/231

(57) ABSTRACT

The present disclosure relates to methods and devices for wireless communication including an apparatus, e.g., a UE and/or a cell or base station. In one aspect, the apparatus can receive DCI from a first cell of a plurality of cells, the DCI indicating at least one of a plurality of TCI states, a plurality of PL RS IDs, or a plurality of spatial relation information IDs which correspond to one or more PCIs, each of the one or more PCIs being associated with one cell. The apparatus can also determine a first PCI associated with the first cell based on at least one of a first TCI state, a first PL RS ID, or a first spatial relation information ID which correspond to the first PCI. Further, the apparatus can communicate with the first cell over a first beam based on the determined first PCI.

### CROSS REFERENCE TO RELATED APPLICATION(S)

This application is National Stage Application filed under 35 U.S.C. § 371 of PCT International Application No. PCT/CN2020/106152, entitled “METHODS AND APPARATUS FOR BEAM ACTIVATION BASED ON PCI” and filed Jul. 31, 2020, which is expressly incorporated by reference herein in its entirety.

### BACKGROUND

### Technical Field

The present disclosure relates generally to communication systems, and more particularly, to beam transmissions in wireless communication systems. Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced (pc)mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells. The apparatus may also receive a medium access control (MAC) control element (MAC-CE) indicating a first PCI associated with the first cell. Additionally, the apparatus may determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI. The apparatus may also communicate with the first cell over a first beam based on the determined first PCI associated with the first cell.

In another aspect of the disclosure, a method, a computer-readable medium, and an apparatus are provided. The apparatus may be a cell or base station. The apparatus may transmit downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell. The apparatus may also transmit a medium access control (MAC) control element (MAC-CE) indicating the at least one PCI associated with the cell. Further, the apparatus may communicate with the UE over a first beam based on the at least one PCI associated with the cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example communication between a UE and cells in accordance with one or more techniques of the present disclosure.

FIG. 5 is a diagram illustrating example communication between UEs and cells in accordance with one or more techniques of the present disclosure.

FIG. 6 is an example structure of a MAC-CE in accordance with one or more techniques of the present disclosure.

FIG. 7 is a diagram illustrating example communication between a UE and a base station in accordance with one or more techniques of the present disclosure.

FIG. 8 is a diagram illustrating example communication between a UE and a base station in accordance with one or more techniques of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

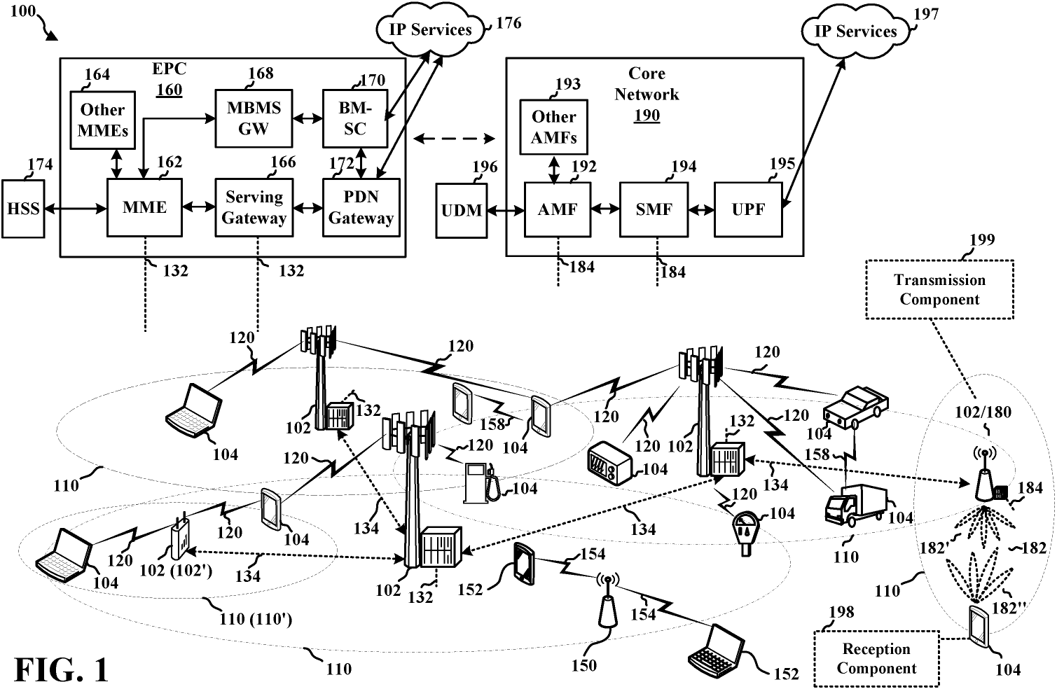

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102 / UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152 / AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz - 7.125 GHz) and FR2 (24.25 GHz - 52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180 / UE 104 may perform beam training to determine the best receive and transmit directions for each of the base station 180 / UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells. Reception component 198 may also be configured to receive a medium access control (MAC) control element (MAC-CE) indicating a first PCI associated with the first cell. Reception component 198 may also be configured to determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI. Reception component 198 may also be configured to communicate with the first cell over a first beam based on the determined first PCI associated with the first cell.

Referring again to FIG. 1, in certain aspects, the base station 180 may include a transmission component 199 configured to transmit downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell. Transmission component 199 may also be configured to transmit a medium access control (MAC) control element (MAC-CE) indicating the at least one PCI associated with the cell. Transmission component 199 may also be configured to communicate with the UE over a first beam based on the at least one PCI associated with the cell.

Although the following description may be focused on 5G NR, the concepts described herein may be applicable to other similar areas, such as LTE, LTE-A, CDMA, GSM, and other wireless technologies.

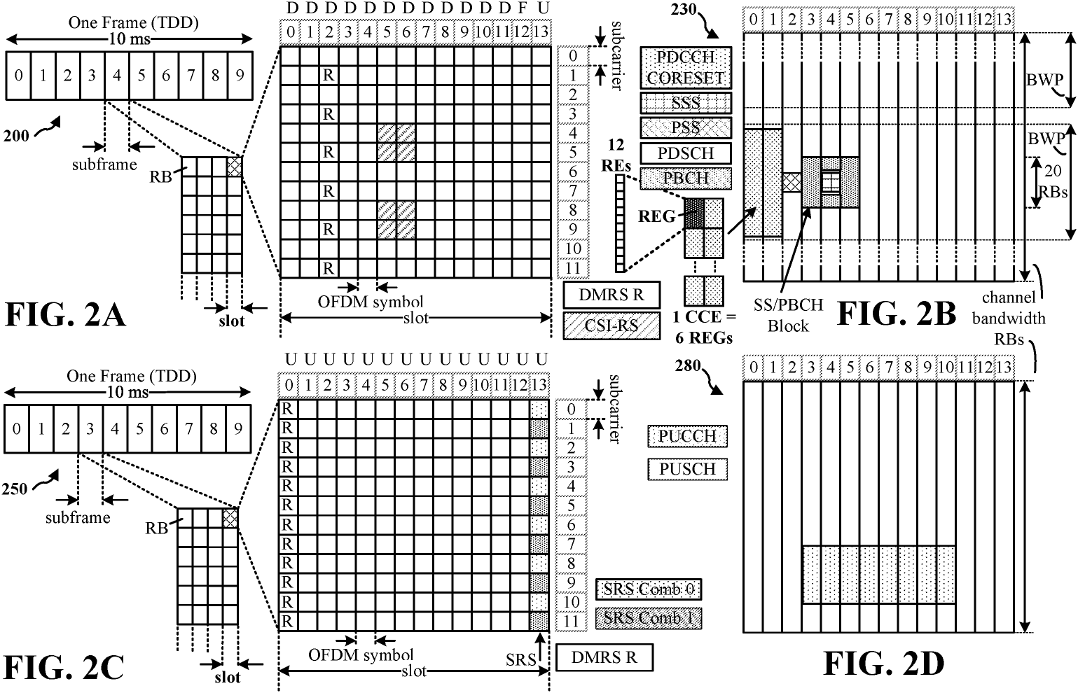

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies µ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology µ, there are 14 symbols/slot and 2^{µ} slots/subframe. The subcarrier spacing and symbol length/duration are a function of the numerology. The subcarrier spacing may be equal to 2^{µ} * 15 kHz, where µ is the numerology 0 to 4. As such, the numerology µ=0 has a subcarrier spacing of 15 kHz and the numerology µ=4 has a subcarrier spacing of 240 kHz. The symbol length/duration is inversely related to the subcarrier spacing. FIGS. 2A-2D provide an example of slot configuration 0 with 14 symbols per slot and numerology µ=2 with 4 slots per subframe. The slot duration is 0.25 ms, the subcarrier spacing is 60 kHz, and the symbol duration is approximately 16.67 µs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

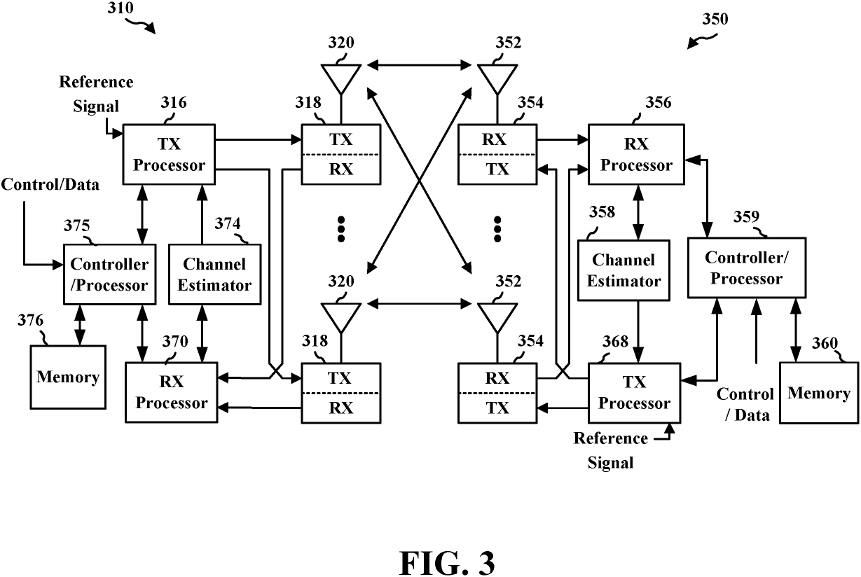

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression / decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Some aspects of wireless communications can include beam switching across different cells or base stations, e.g., serving cells and non-serving cells. For instance, 5G new radio (NR) wireless communications can include layer 1 (L1) or layer 2 (L2) based inter-cell mobility based on enhanced beam management (BM). So rather than utilizing an RRC layer for a handover, wireless communications can introduce L1/L2 inter-cell mobility to reduce communication latency. In some aspects, mobility can be improved via beam switching across serving and non-serving cells. Each potential serving cell or neighbor cell may include a pre-selected physical cell identify (PCI), such that the beam switching procedure may be faster. Also, each serving cell may have single or multiple cells or transmit-receive points (TRPs), which can share a same PCI.

In some aspects, a transmission configuration indication (TCI) state or spatial relation for a downlink (DL) or uplink (UL) beam of the serving cell can utilize quasi co-location (QCL). For instance, the physical channels of serving cell can be quasi co-located (QCLed) with a synchronization signal block (SSB) from a PCI of a serving cell or a neighbor non-serving cell. In some instances, there may be a single TRP per serving cell or base station. There may also be multiple TRPs per serving cell or base station. Additionally, reference signals from neighbor non-serving cells may be utilized for beam indication to the physical channel of the serving cell.

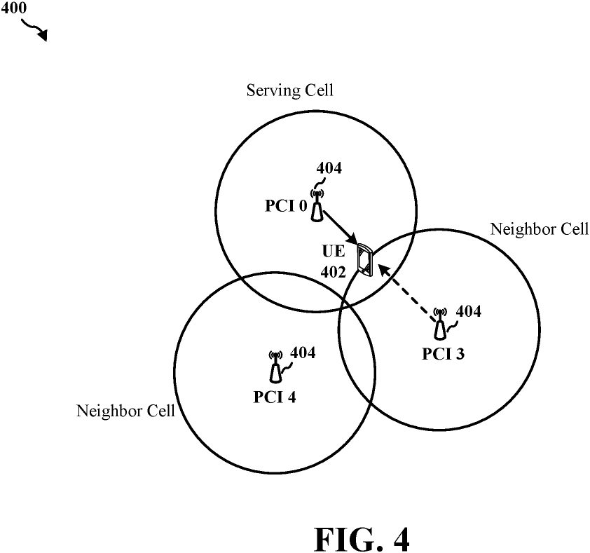

FIG. 4 is a diagram 400 illustrating example communication between a UE 402 and cells or base stations 404. As shown in FIG. 4, the UE 402 may be served by PCI 0 that is associated with base station 404, while PCI 3 and PCI 4 are neighbor cells. In diagram 400, L1/L2 inter-cell mobility may occur via beam switching across serving and non-serving cells. Each serving cell may have a single or multiple TRPs, e.g., base station, sharing the same PCI. The example of FIG. 4 includes a configuration with a single TRP per serving cell.

In FIG. 4, a TCI state or spatial relation for the downlink or uplink beam of the serving cell may be quasi co-located (QCL) with SSB from the PCI of the same serving cell or a neighbor non-serving cell. For example, as shown in FIG. 4, the TCI state may be QCLed with the SSB from PCI 0. In some instances, the TCI state or spatial relation information in neighbor non-serving cell may be utilized to provide a beam indication.

As shown in FIG. 4, there may be one or more TRPs per serving cell or base station. Also, a TCI state, e.g., for downlink communication, of the serving cell can be QCLed with an SSB or SSB ID from a PCI of same serving cell or a neighbor non-serving cell. Also, spatial relation information can be used for uplink communication. In some instances, the TCI state or spatial relation information of neighbor non-serving cells can be used for a beam indication for a potential future beam switch.

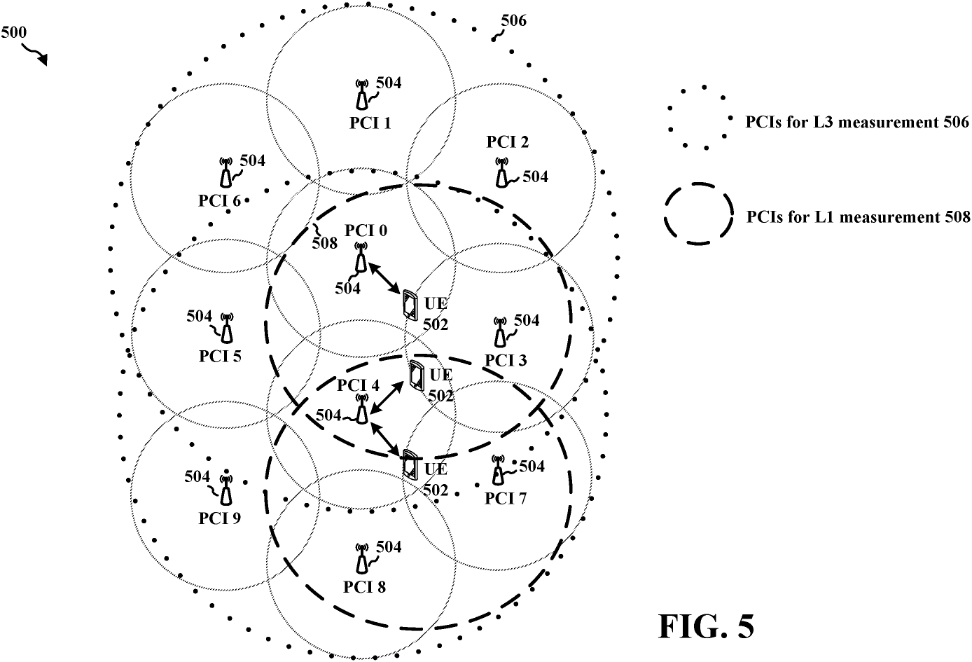

FIG. 5 is a diagram 500 illustrating example communication between UE 502 and cells or base stations 504. FIG. 5 displays a beam switch procedure in aspects of wireless communication. The diagram 500 includes UE 502, cells or base stations 504 including PCIs, e.g., PCI 0 to PCI 9, PCIs for an L3 measurement 506, and PCIs for an L1 measurement 508.

In a first step of the beam switch procedure in FIG. 5, the UE 502 can enter connected mode after initial access (IA) on a serving cell with a PCI, e.g., PCI 0. In a second step of the beam switch procedure in FIG. 5, the UE 502 can measure and report a layer 3 (L3) metric for neighboring PCIs, e.g., PCI 1 to PCI 6, detected by the UE or a searcher. So the UE 502 can detect neighboring PCIs that pass an L3 threshold and surround the serving cell.

In a third step of the beam switch procedure in FIG. 5, based on an L3 report, a cell or base station can configure TCI states associated with certain PCIs, e.g., PCI 0, PCI 3, PCI 4, where PCI 3 and PCI 4 may be from neighbor non-serving cells. The UE 502 can be further configured with an L1 measurement or metric, e.g., reference signal received power (RSRP) or signal-to-interference plus noise ratio (SINR), for those configured TCI states. These PCIs, e.g., PCI 0, PCI 3, PCI 4, may be defined as the L1 measurement PCI set 508. Also, the L1 metric can be a short term metric, while the L3 metric can be a longer term metric compared to the L1 metric. In some aspects, the UE 502 can take the L1 or L3 measurements, and then send the L1 or L3 report to the base station.

In a fourth step of the beam switch procedure in FIG. 5, based on an L1 measurement or report from the UE, the base station may activate one TCI state associated with a neighboring PCI, e.g., PCI 4, to serve the UE. This may be because the UE moved away from the serving cell and closer to the neighboring cell. The L1 measurement or report can include an SSB ID and a metric, e.g., RSRP or SINR. In a fifth step of the beam switch procedure, based on an updated L3 report, the base station can move the serving cells from PCI 0 to PCI 4. The cell or base station may also configure new TCI states associated with an updated L1 measurement PCI set, e.g., PCI 4, PCI 7, or PCI 8.

Some aspects of wireless communication can utilize beam and/or path loss (PL) reference signal (RS) activation per physical cell identity (PCI). In L1 or L2 inter-cell mobility, different TRPs associated with different PCIs can schedule downlink (DL) or uplink (UL) signals separately. This may be similar to communication protocols in other aspects of wireless communication, e.g., multiple downlink control information (DCI) (mDCI) based multiple transmit-receive point (TRP) (mTRP) communication.

In some aspects, the DCI from a TRP can include a beam indication, e.g., a downlink or uplink transmission configuration indication (TCI) state identifier (ID) or spatial relation ID, and/or a path loss (PL) RS indication, e.g., a PL RS ID. In some instances, in order to reduce the amount of overhead for these indications, a codepoint with a reduced amount of bits may be carried in the DCI instead of a full ID. For instance, as the codepoint may be the local index among activated IDs, this can result in a reduced overhead. In instances of separate scheduling by different TRPs, the overhead can be further reduced by using codepoints as a local index among activated beams or PL RS IDs that are associated with the scheduling TRP.

Based on the above, there is a present need to reduce the amount of bits in the DCI, e.g., by utilizing codepoints, rather than utilizing a full identifier. There is also a present need to use codepoints as a local index per PCI. Further, there is a present need to utilize downlink or uplink beam IDs and/or a PL RS ID for uplink power control to be activated per PCI.

Aspects of the present disclosure can reduce the amount of bits in the DCI, e.g., by utilizing codepoints in the DCI, instead of utilizing a full identifier. For instance, aspects of the present disclosure can utilize codepoints as a local index per PCI. Additionally, aspects of the present disclosure can utilize downlink or uplink beam IDs and/or a PL RS ID for uplink power control to be activated per PCI.

In some aspects, the present disclosure can utilize beam IDs, e.g., TCI state IDs and/or a spatial relation information IDs, and PL RS activation per PCI. For instance, the downlink or uplink beam ID and the PL RS ID for uplink power control may be activated per PCI. For example, the UE can be configured with a list of beam IDs or PL RS IDs per PCI, and a subset of the beam IDs or PL RS IDs in the list can be activated. The UE can also receive the activation indication per PCI. Also, the activated beam ID or PL RS ID may be represented by a PCI-specific codepoint with a reduced amount of bits compared to a full ID of a beam ID or a PL RS ID. By doing so, the present disclosure can reduce the amount of bits in the DCI carrying the indications. For example, for a given PCI, each activated ID may be mapped to a PCI-specific codepoint based on the order of activated IDs for the PCI.

In some instances, in order to reduce the amount of bits in a PCI-specific activation medium access control (MAC) control element (MAC-CE), the beam ID or PL RS ID configured in a list for the PCI may be carried in the activation MAC-CE. Accordingly, the beam ID or PL RS ID may be the candidate IDs for activation of the PCI. In some aspects, the activation MAC-CE may not carry candidate IDs configured in a list for other PCIs.

Additionally, the downlink or uplink beam ID may include a downlink or uplink TCI state ID and/or a spatial relation information ID. The PL RS ID may refer to a PL RS used for uplink power control for an uplink beam. Also, the per-PCI activated beam ID or PL RS ID and the corresponding PCI can be applied to multiple component carriers (CCs) in a case of carrier aggregation, which can be indicated in a CC list configured by radio resource control (RRC) signaling. For instance, if the activation MAC-CE indicates a serving cell ID to be applied with the activation command and the indicated serving cell ID is included in an RRC configured CC list, then the activated IDs may be applied to each of the CCs in the CC list.

Moreover, aspects of the present disclosure can help a UE to identify a PCI associated with each configured beam ID and/or PL RS ID. In some aspects, a PCI associated with a beam ID, e.g., a TCI state ID and/or a spatial relation information ID, may be determined by the PCI of a synchronization signal block (SSB) as a root quasi co-location (QCL) source for an indicated beam. Additionally, for a TCI state with an SSB as a QCL source, the PCI associated with the TCI state may be the PCI of the SSB. Further, for a TCI state without an SSB as a QCL source, the associated PCI may be the PCI of the SSB as a root in a QCL chain of the TCI state.

In some instances, a PCI associated with a beam ID may be explicitly configured together with the beam ID, e.g., a TCI state ID and/or a spatial relation information ID. For example, a PCI may be indicated as a separate field in each configured downlink or uplink TCI state or spatial relation information, regardless of whether the beam indication RS in the TCI state or spatial relation information is in a particular SSB.

In some aspects, a number of PDSCH TCI states can be activated per PCI in order to reduce the amount of TCI codepoint bits in DCI. The PDSCH TCI states can also be activated across multiple CCs in order to reduce the amount of MAC-CE bits. To further reduce the amount of MAC-CE bits, the actual PCI, e.g., 10 bits, may be replaced by a PCI ID with a fewer amount of bits. For example, for certain PCIs configured in an L1 measurement, PCI sets can be mapped to a PCI ID based on the order in the set. For example, when PCIs 0, 3, 4 are configured in the L1 measurement and each full PCI ID has 10 bits, the PCI IDs may be mapped as 0, 1, 2 in the activation MAC-CE based on their order in the set of L 1 measurement, instead of using a 10-bit full PCI ID for each PCI. In addition, a MAC-CE may be activated among configured TCI states associated with an indicated PCI in order to reduce the amount of overhead. For example, a certain TCI state may map to a lowest configured TCI ID for an indicated PCI.

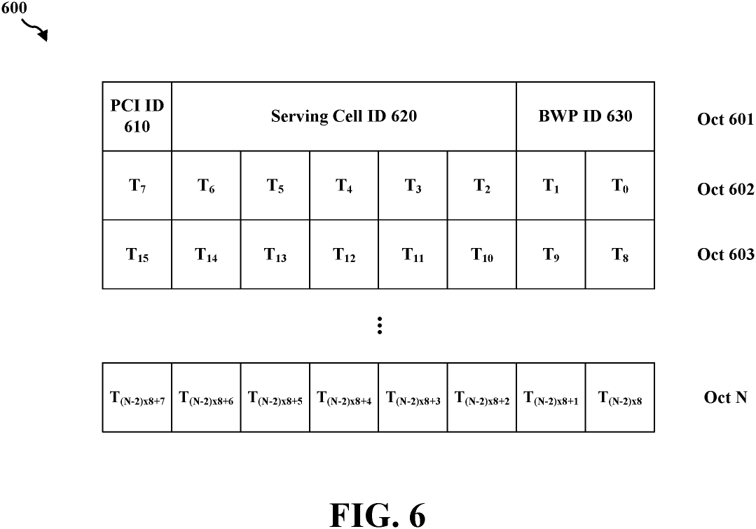

FIG. 6 is a structure of a MAC-CE 600. More specifically, FIG. 6 shows MAC-CE 600 including a bitmap for multiple resources. As displayed in FIG. 6, MAC-CE 600 includes a number of fields or bits that are arranged in different of octets, e.g., octet 601, octet 602, octet 603, and octet N. FIG. 6 shows that the PCI ID field 610 may be one (1) bit, the serving cell ID field 620 may be five (5) bits, and the BWP ID field 630 may be two (2) bits, e.g., in octet 601. The TCI states may be in the form of a bitmap, with each bit corresponding to a TCI state ID. For example, TCI state IDs T₀ through T₇ may be in octet 602. Also, TCI state IDs T₈ through T₁₅ may be in octet 603. As shown in FIG. 6, the TCI states can be up through T(_{N-2})ₓ₈₊₇ in octet N. The TCI states in the MAC-CE may correspond to the TCI states configured in the list for the PCI indicated in the MAC-CE. For example, up to 64 TCI states can be configured in a list for a PCI ID. The bit T₀ may correspond to the lowest TCI state ID in the list configured for the PCI ID. When the bit in the bitmap is indicated as 1 in the MAC-CE, the TCI ID corresponding to the bit may be activated, otherwise the TCI ID may not be activated. When there are multiple TCI states activated for a PCI ID in the MAC-CE, the TCI codepoints in DCI associated with the PCI may be mapped in order to the activated TCI states for the PCI ID in the MAC-CE. As shown in FIG. 6, to reduce the amount of MAC-CE bits, the actual PCI may be replaced by a PCI ID field, e.g., PCI ID field 610, with a fewer amount of bits, e.g., one (1) bit in MAC-CE 600 can indicate one of two configured PCI IDs.

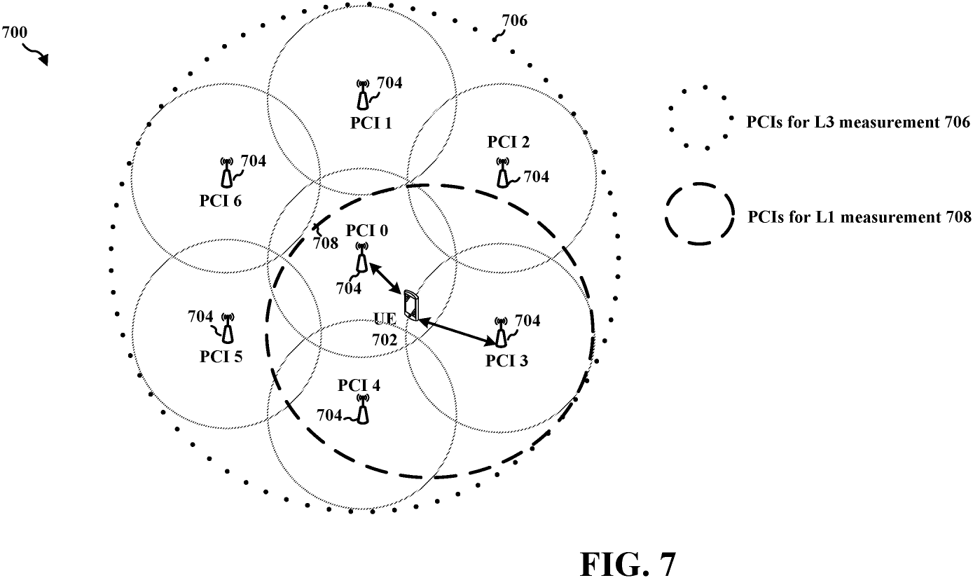

FIG. 7 is a diagram 700 illustrating example communication between UE 702 and cells or base stations 704. FIG. 7 displays a beam switch procedure in aspects of wireless communication. The diagram 700 includes UE 702, cells or base stations 704 including a number of different PCIs, e.g., PCI 0 to PCI 9. Diagram 700 also includes PCIs for an L3 measurement 706, as well as PCIs for an L1 measurement 708.

FIG. 7 displays a beam switch procedure that can reduce the amount of MAC-CE bits. For instance, the actual PCI may be replaced by a PCI ID with a fewer amount of bits. As shown in FIG. 7, for certain PCIs in an L1 measurement 708, e.g., PCI 0, PCI 3, and PCI 4, the PCI sets can be mapped to a PCI ID based on the order in the set. For example, PCI sets can be mapped to PCI ID 0, PCI ID 1, or PCI ID 2. Further, a MAC-CE may be activated among configured TCI states associated with an indicated PCI in order to reduce the amount of overhead. Also, a certain TCI state, e.g., T_0, may map to a lowest configured TCI ID for an indicated PCI, e.g., PCI 0.

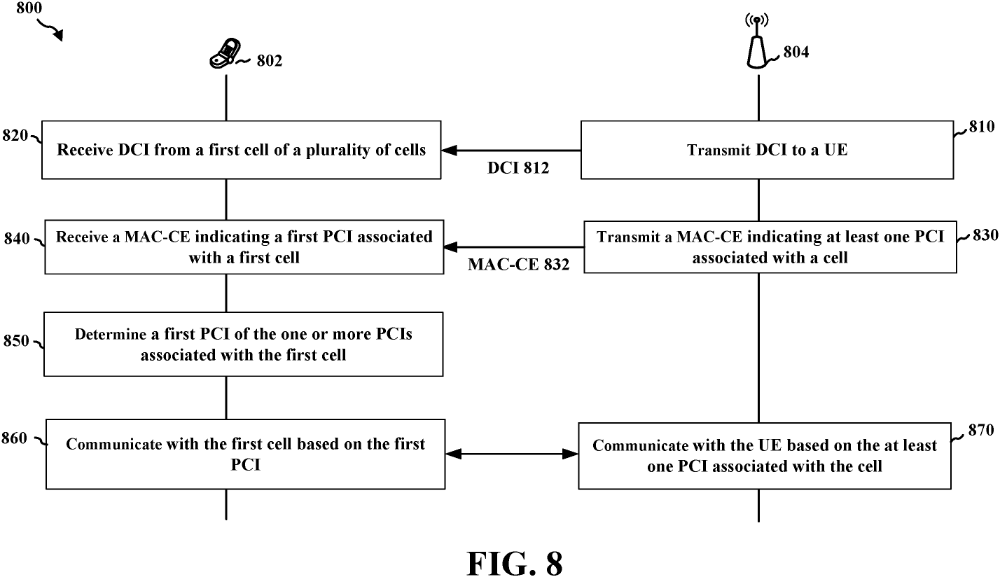

FIG. 8 is a diagram 800 illustrating example communication between a UE 802 and a cell or base station 804.

At 810, cell 804 may transmit DCI, e.g., DCI 812, to a UE, e.g., UE 802, the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell.

At 820, UE 802 may receive DCI, e.g., DCI 812, from a first cell of a plurality of cells, e.g., cell 804, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells.

At 830, cell 804 may transmit a medium access control (MAC) control element (MAC-CE), e.g., MAC-CE 832, indicating the at least one PCI associated with the cell. At 840, UE 802 may receive a medium access control (MAC) control element (MAC-CE), e.g., MAC-CE 832, indicating a first PCI associated with the first cell. In some aspects, the MAC-CE may include a plurality of codepoints for a PCI field, the first PCI may be associated with the first cell corresponding to at least one codepoint of the plurality of codepoints.

At 850, UE 802 may determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI. The at least one of the first TCI state, the first PL RS ID, or the first spatial relation information ID may be indicated by a codepoint.

In some aspects, the first PCI may be determined based on a synchronization signal block (SSB) of the first beam. Also, the SSB of the first beam may correspond to a quasi co-location (QCL) source for the first beam, the first PCI corresponding to a PCI of the SSB. A PCI of the SSB may be associated with a root of a quasi co-location (QCL) chain of the first TCI state. Further, the first PCI may be configured with at least one of the first TCI state or the first spatial relation information ID. The first PCI may be indicated by a field of the first TCI state or a field of the first spatial relation information ID.

Additionally, at least one of the first TCI state or the first spatial relation information ID may correspond to a beam ID for the first beam. The first TCI state may correspond to a lowest TCI state of the plurality of TCI states. Also, the first PCI associated with the first cell may correspond to one or more component carriers (CCs). The one or more CCs may be indicated in a CC list via radio resource control (RRC) signaling. Further, the first cell may correspond to one or more transmit-receive points (TRPs).

At 860, UE 802 may communicate with the first cell, e.g., cell 804, over a first beam based on the determined first PCI associated with the first cell. At 870, cell 804 may communicate with the UE, e.g., UE 802, over a first beam based on the at least one PCI associated with the cell.

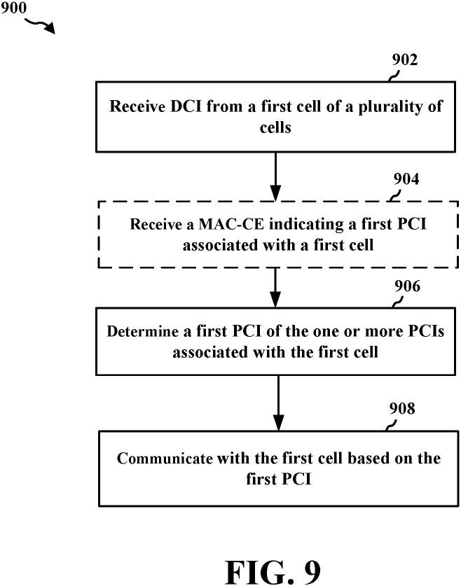

FIG. 9 is a flowchart 900 of a method of wireless communication. The method may be performed by a UE or a component of a UE (e.g., the UE 104, 350, 802; the apparatus 1102; a processing system, which may include the memory 360 and which may be the entire UE or a component of the UE, such as the TX processor 368, the controller/processor 359, transmitter 354TX, antenna(s) 352, and/or the like). Optional aspects are illustrated with a dashed line. The methods described herein can provide a number of benefits, such as improving communication signaling, resource utilization, and/or power savings.

At 902, the apparatus may receive DCI from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells, as described in connection with the examples in FIGS. 4, 5, 6, 7, and 8. For example, 902 may be performed by determination component 1140.

At 904, the apparatus may receive a medium access control (MAC) control element (MAC-CE) indicating a first PCI associated with the first cell, as described in connection with the examples in FIGS. 4, 5, 6, 7, and 8. For example, 904 may be performed by determination component 1140. In some aspects, the MAC-CE may include a plurality of codepoints for a PCI field, the first PCI associated with the first cell corresponding to at least one codepoint of the plurality of codepoints, as described in connection with the examples in FIGS. 4, 5, 6, 7, and 8.

At 906, the apparatus may determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI, as described in connection with the examples in FIGS. 4, 5, 6, 7, and 8. For example, 906 may be performed by determination component 1140. The at least one of the first TCI state, the first PL RS ID, or the first spatial relation information ID may be indicated by a codepoint, as described in connection with the examples in FIGS. 4, 5, 6, 7, and 8.

In some aspects, the first PCI may be determined based on a synchronization signal block (SSB) of the first beam, as described in connection with the examples in FIGS. 4, 5, 6, 7, and 8. Also, the SSB of the first beam may correspond to a quasi co-location (QCL) source for the first beam, the first PCI corresponding to a PCI of the SSB, as described in connection with the examples in FIGS. 4, 5, 6, 7, and 8. A PCI of the SSB may be associated with a root of a quasi co-location (QCL) chain of the first TCI state, as described in connection with the examples in FIGS. 4, 5, 6, 7, and 8. Further, the first PCI may be configured with at least one of the first TCI state or the first spatial relation information ID, as described in connection with the examples in FIGS. 4, 5, 6, 7, and 8. The first PCI may be indicated by a field of the first TCI state or a field of the first spatial relation information ID, as described in connection with the examples in FIGS. 4, 5, 6, 7, and 8.

Additionally, at least one of the first TCI state or the first spatial relation information ID may correspond to a beam ID for the first beam, as described in connection with the examples in FIGS. 4, 5, 6, 7, and 8. The first TCI state may correspond to a lowest TCI state of the plurality of TCI states, as described in connection with the examples in FIGS. 4, 5, 6, 7, and 8. Also, the first PCI associated with the first cell may correspond to one or more component carriers (CCs), as described in connection with the examples in FIGS. 4, 5, 6, 7, and 8. The one or more CCs may be indicated in a CC list via radio resource control (RRC) signaling, as described in connection with the examples in FIGS. 4, 5, 6, 7, and 8. Further, the first cell may correspond to one or more transmit-receive points (TRPs), as described in connection with the examples in FIGS. 4, 5, 6, 7, and 8.

At 908, the apparatus may communicate with the first cell over a first beam based on the determined first PCI associated with the first cell, as described in connection with the examples in FIGS. 4, 5, 6, 7, and 8. For example, 908 may be performed by determination component 1140.

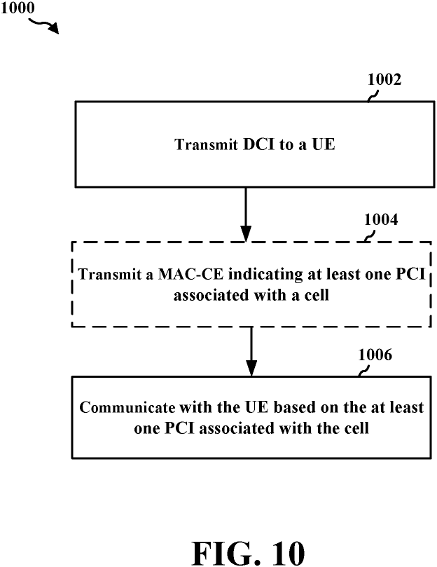

FIG. 10 is a flowchart 1000 of a method of wireless communication. The method may be performed by a cell or base station or a component of a cell or base station (e.g., the base station 102, 180, 310, 804; the apparatus 1202; a processing system, which may include the memory 376 and which may be the entire base station or a component of the base station, such as the antenna(s) 320, receiver 318RX, the RX processor 370, the controller/processor 375, and/or the like). Optional aspects are illustrated with a dashed line. The methods described herein can provide a number of benefits, such as improving communication signaling, resource utilization, and/or power savings.

At 1002, the apparatus may transmit downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell, as described in connection with the examples in FIGS. 4, 5, 6, 7, and 8. For example, 1002 may be performed by determination component 1240. The at least one of the TCI state, the PL RS ID, or the spatial relation information ID may be indicated by a codepoint, as described in connection with the examples in FIGS. 4, 5, 6, 7, and 8.

In some aspects, the at least one PCI may be based on a synchronization signal block (SSB) of the first beam, as described in connection with the examples in FIGS. 4, 5, 6, 7, and 8. The SSB of the first beam may correspond to a quasi co-location (QCL) source for the first beam, the at least one PCI corresponding to a PCI of the SSB, as described in connection with the examples in FIGS. 4, 5, 6, 7, and 8. Also, a PCI of the SSB may be associated with a root of a quasi co-location (QCL) chain of the TCI state, as described in connection with the examples in FIGS. 4, 5, 6, 7, and 8. Further, the at least one PCI may be configured with at least one of the TCI state or the spatial relation information ID, as described in connection with the examples in FIGS. 4, 5, 6, 7, and 8. The at least one PCI may be indicated by a field of the TCI state or a field of the spatial relation information ID, as described in connection with the examples in FIGS. 4, 5, 6, 7, and 8.

At 1004, the apparatus may transmit a medium access control (MAC) control element (MAC-CE) indicating the at least one PCI associated with the cell, as described in connection with the examples in FIGS. 4, 5, 6, 7, and 8. For example, 1004 may be performed by determination component 1240. The MAC-CE may include a plurality of codepoints for a PCI field, the at least one PCI may be associated with the cell corresponding to at least one codepoint of the plurality of codepoints, as described in connection with the examples in FIGS. 4, 5, 6, 7, and 8.

In some aspects, at least one of the TCI state or the spatial relation information ID may correspond to a beam ID for the first beam, as described in connection with the examples in FIGS. 4, 5, 6, 7, and 8. The TCI state may correspond to a lowest TCI state of a plurality of TCI states, as described in connection with the examples in FIGS. 4, 5, 6, 7, and 8. Also, the at least one PCI associated with the cell may correspond to one or more component carriers (CCs), as described in connection with the examples in FIGS. 4, 5, 6, 7, and 8. The one or more CCs may be indicated in a CC list via radio resource control (RRC) signaling, as described in connection with the examples in FIGS. 4, 5, 6, 7, and 8. Moreover, the cell may correspond to one or more transmit-receive points (TRPs), as described in connection with the examples in FIGS. 4, 5, 6, 7, and 8.

At 1006, the apparatus may communicate with the UE over a first beam based on the at least one PCI associated with the cell, as described in connection with the examples in FIGS. 4, 5, 6, 7, and 8. For example, 1006 may be performed by determination component 1240.

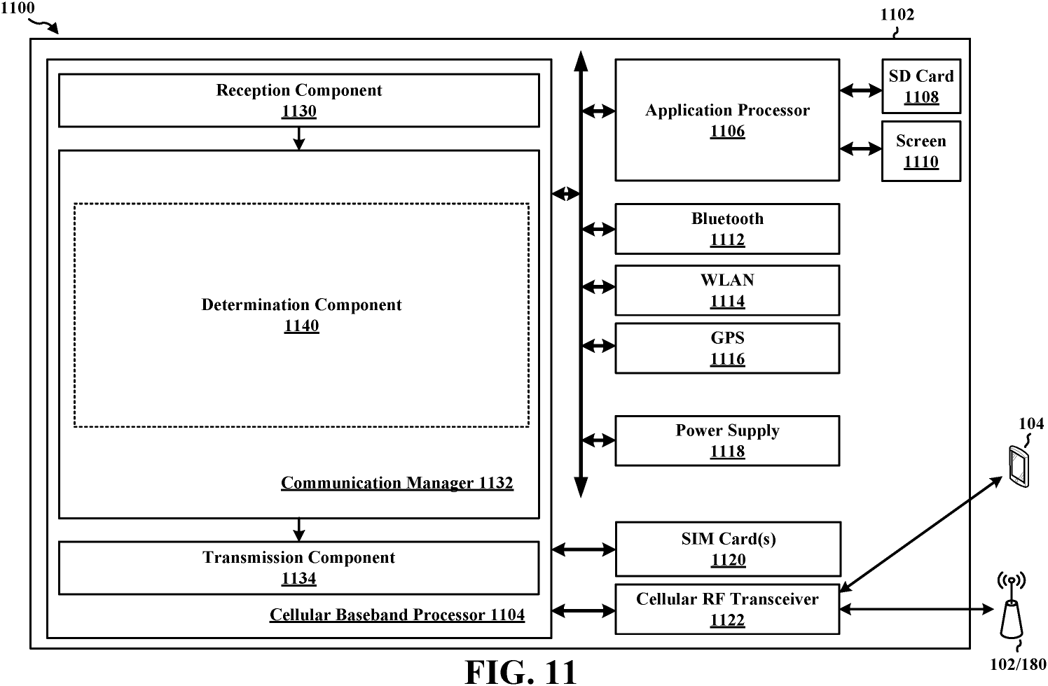

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium / memory. The computer-readable medium / memory may be non-transitory. The cellular baseband processor 1104 is responsible for general processing, including the execution of software stored on the computer-readable medium / memory. The software, when executed by the cellular baseband processor 1104, causes the cellular baseband processor 1104 to perform the various functions described supra. The computer-readable medium / memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium / memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforediscussed additional modules of the apparatus 1102.

The communication manager 1132 includes a determination component 1140 that is configured to receive downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells, e.g., as described in connection with step 902 above. Determination component 1140 can also be configured to determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI, e.g., as described in connection with step 906 above. Determination component 1140 can also be configured to communicate with the first cell over a first beam based on the determined first PCI associated with the first cell, e.g., as described in connection with step 908 above.

The apparatus may include additional components that perform each of the blocks of the algorithm in the aforementioned flowcharts of FIGS. 8 and 9. As such, each block in the aforementioned flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for receiving downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells. The apparatus 1102 can also include means for determining a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI. The apparatus 1102 can also include means for communicating with the first cell over a first beam based on the determined first PCI associated with the first cell. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

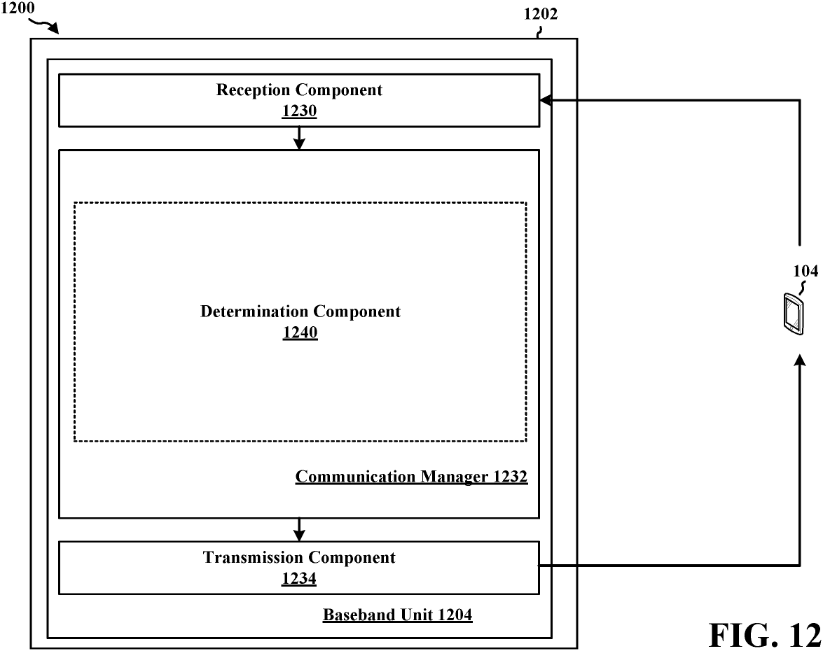

FIG. 12 is a diagram 1200 illustrating an example of a hardware implementation for an apparatus 1202. The apparatus 1202 is a base station and includes a baseband unit 1204. The baseband unit 1204 may communicate through a cellular RF transceiver with the UE 104. The baseband unit 1204 may include a computer-readable medium / memory. The baseband unit 1204 is responsible for general processing, including the execution of software stored on the computer-readable medium / memory. The software, when executed by the baseband unit 1204, causes the baseband unit 1204 to perform the various functions described supra. The computer-readable medium / memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium / memory and/or configured as hardware within the baseband unit 1204. The baseband unit 1204 may be a component of the BS 310 and may include the memory 376 and/or at least one of the TX processor 316, the RX processor 370, and the controller/processor 375.

The communication manager 1232 includes a determination component 1240 that is configured to transmit downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell, e.g., as described in connection with step 1002 above. Determination component 1240 can also be configured to communicate with the UE over a first beam based on the at least one PCI associated with the cell, e.g., as described in connection with step 1006 above.

The apparatus may include additional components that perform each of the blocks of the algorithm in the aforementioned flowcharts of FIGS. 8 and 10. As such, each block in the aforementioned flowcharts of FIGS. 8 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for transmitting downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell. The apparatus 1202 can also include means for communicating with the UE over a first beam based on the at least one PCI associated with the cell. The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells;
determining a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI; and
communicating with the first cell over a first beam based on the determined first PCI associated with the first cell.

2. The method of claim 1, wherein the first PCI is determined based on a synchronization signal block (SSB) of the first beam.

3. The method of claim 2, wherein the SSB of the first beam corresponds to a quasi co-location (QCL) source for the first beam, the first PCI corresponding to a PCI of the SSB.

4. The method of claim 2, wherein a PCI of the SSB is associated with a root of a quasi co-location (QCL) chain of the first TCI state.

5. The method of claim 1, wherein the first PCI is configured with at least one of the first TCI state or the first spatial relation information ID.

6. The method of claim 5, wherein the first PCI is indicated by a field of the first TCI state or a field of the first spatial relation information ID.

7. The method of claim 1, wherein the at least one of the first TCI state, the first PL RS ID, or the first spatial relation information ID is indicated by a codepoint.

8. The method of claim 1, further comprising:
receiving a medium access control (MAC) control element (MAC-CE) indicating the first PCI associated with the first cell.

9. The method of claim 8, wherein the MAC-CE includes a plurality of codepoints for a PCI field, the first PCI associated with the first cell corresponding to at least one codepoint of the plurality of codepoints.

10. The method of claim 1, wherein at least one of the first TCI state or the first spatial relation information ID corresponds to a beam ID for the first beam.

11. The method of claim 1, wherein the first TCI state corresponds to a lowest TCI state of the plurality of TCI states.

12. The method of claim 1, wherein the first PCI associated with the first cell corresponds to one or more component carriers (CCs).

13. The method of claim 12, wherein the one or more CCs are indicated in a CC list via radio resource control (RRC) signaling.

14. The method of claim 1, wherein the first cell corresponds to one or more transmit-receive points (TRPs).

15. An apparatus for wireless communication of a user equipment (UE), comprising:
a memory; and
at least one processor coupled to the memory and configured to:
receive downlink control information (DCI) from a first cell of a plurality of cells, the DCI indicating at least one of a plurality of transmission configuration indication (TCI) states, a plurality of path loss (PL) reference signal (RS) identifiers (IDs), or a plurality of spatial relation information IDs, the at least one of the plurality of TCI states, the plurality of PL RS IDs, or the plurality of spatial relation information IDs corresponding to one or more physical cell identities (PCIs), each of the one or more PCIs being associated with one of the plurality of cells;
determine a first PCI of the one or more PCIs associated with the first cell based on at least one of a first TCI state of the plurality of TCI states, a first PL RS ID of the plurality of PL RS IDs, or a first spatial relation information ID of the plurality of spatial relation information IDs, the at least one of the first TCI state, the first PL RS ID, or the first spatial relation information ID corresponding to the first PCI; and
communicate with the first cell over a first beam based on the determined first PCI associated with the first cell.

16. The apparatus of claim 15, wherein the first PCI is determined based on a synchronization signal block (SSB) of the first beam.

17. The apparatus of claim 16, wherein the SSB of the first beam corresponds to a quasi co-location (QCL) source for the first beam, the first PCI corresponding to a PCI of the SSB.

18. The apparatus of claim 16, wherein a PCI of the SSB is associated with a root of a quasi co-location (QCL) chain of the first TCI state.

19. The apparatus of claim 15, wherein the first PCI is configured with at least one of the first TCI state or the first spatial relation information ID.

20. The apparatus of claim 19, wherein the first PCI is indicated by a field of the first TCI state or a field of the first spatial relation information ID.

21. The apparatus of claim 15, wherein the at least one of the first TCI state, the first PL RS ID, or the first spatial relation information ID is indicated by a codepoint.

22. The apparatus of claim 15, wherein the at least one processor is further configured to:
receive a medium access control (MAC) control element (MAC-CE) indicating the first PCI associated with the first cell.

23. The apparatus of claim 22, wherein the MAC-CE includes a plurality of codepoints for a PCI field, the first PCI associated with the first cell corresponding to at least one codepoint of the plurality of codepoints.

24. The apparatus of claim 15, wherein at least one of the first TCI state or the first spatial relation information ID corresponds to a beam ID for the first beam.

25. The apparatus of claim 15, wherein the first TCI state corresponds to a lowest TCI state of the plurality of TCI states.

26. The apparatus of claim 15, wherein the first PCI associated with the first cell corresponds to one or more component carriers (CCs).

27. The apparatus of claim 26, wherein the one or more CCs are indicated in a CC list via radio resource control (RRC) signaling.

28. The apparatus of claim 15, wherein the first cell corresponds to one or more transmit-receive points (TRPs).

29-57. (canceled)

58. An apparatus for wireless communication of a cell, comprising:
a memory; and
at least one processor coupled to the memory and configured to:
transmit downlink control information (DCI) to a user equipment (UE), the DCI indicating at least one of a transmission configuration indication (TCI) state, a path loss (PL) reference signal (RS) identifier (ID), or a spatial relation information ID, the at least one of the TCI state, the PL RS ID, or the spatial relation information ID corresponding to at least one physical cell identity (PCI), the at least one PCI being associated with the cell; and
communicate with the UE over a first beam based on the at least one PCI associated with the cell.

59. The apparatus of claim 58, wherein the at least one PCI is based on a synchronization signal block (SSB) of the first beam.

60-86. (canceled)
